(19) United States
(12) Patent Application Publication
(10) Pub. No.: US 2025/0172744 A1
(43) Pub. Date: May 29, 2025

(54) OPTICAL MEMBER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Masatoshi TSUJI, Nisshin-shi (JP); Kojiro TACHI, Nisshin-shi (JP); Hiroshi ANDO, Nisshin-shi (JP); Heng LIU, Nisshin-shi (JP); Kouji SATOU, Nisshin-shi (JP)

(21) Appl. No.: 18/815,587

(22) Filed: Aug. 26, 2024

(30) Foreign Application Priority Data
Nov. 23, 2023 (JP) 2023-198726

(51) Int. Cl. F21V 8/00

(52) U.S. Cl. CPC G02B 6/0093; G02B 6/0016; G02B 6/0036

(57) ABSTRACT

An optical element has a light guide made of a light-transmitting material. The light guide has an incident portion where an external light enters, an exit portion which includes a surface where light incident from the incident portion first reaches, in which a protruding prism portion and a flat surface are arranged alternately, and a smooth surface opposite to the exit portion as parallel to the flat surface. The exit portion and the smooth surface are opposite to each other in an X direction. The light guide further has a reinforcing portion that protrudes or is recessed in the X direction from the flat surface or the smooth surface.

### CROSS REFERENCE TO RELATED APPLICATION

This application is based on Japanese Patent Application No. 2023-198726 filed on Nov. 23, 2023, the disclosure of which is incorporated herein by reference.

### TECHNICAL FIELD

The present disclosure relates to an optical member.

### BACKGROUND

An optical member is used as a blind spot auxiliary device that projects an image of a blind spot area.

### SUMMARY

According to one aspect of the present disclosure, an optical member that internally reflects and guides an external light includes a light guide made of a light-transmitting material. The light guide includes an incident portion into which an external light enters, an exit portion including a surface onto which light entering from the incident portion first reaches, in which a protruding prism portion and a flat surface are alternately arranged, and a smooth surface opposite to the exit portion and parallel to the flat surface. The exit portion and the smooth surface are opposite to each other in an X direction, and the prism portion and the flat surface are alternately arranged in a Z direction. A direction perpendicular to the X direction and the Z direction is defined as a Y direction. The light guide further has a reinforcing portion that protrudes or is recessed in the X direction from the flat surface or the smooth surface.

### BRIEF DESCRIPTION OF THE DRAWINGS

FIG. 1 is a cross-sectional view illustrating an optical member according to a first embodiment.

FIG. 2 is a side view of the optical member according to the first embodiment.

FIG. 3 is a rear view of the optical member in a direction III in FIG. 2.

FIG. 4 is a side view of an optical member according to a second embodiment.

FIG. 5 is a rear view of the optical member in a direction V in FIG. 4.

FIG. 6 is a side view of an optical member according to a third embodiment.

FIG. 7 is a rear view of the optical member in a direction VIII in FIG. 6.

FIG. 8 is a rear view of an optical member according to a fourth embodiment, which corresponds to FIG. 3.

FIG. 9 is a rear view of an optical member according to a fifth embodiment, which corresponds to FIG. 3.

FIG. 10 is a side view of an optical member according to a sixth embodiment.

FIG. 11 is a rear view of the optical member in a direction XI in FIG. 10.

FIG. 12 is a side view of an optical member according to a seventh embodiment.

FIG. 13 is a rear view of the optical member in a direction XIII in FIG. 12.

FIG. 14 is a plan view of an optical member according to an eighth embodiment.

FIG. 15 is a side view of the optical member in a direction XV in FIG. 14.

FIG. 16 is a rear view of the optical member in a direction XVI in FIGS. 14 and 15.

FIG. 17 is a side view of an optical member according to a ninth embodiment.

FIG. 18 is a rear view of the optical member in a direction XVIII in FIG. 17.

FIG. 19 is a side view of an optical member according to a tenth embodiment.

FIG. 20 is a rear view of the optical member in a direction XX in FIG. 19.

FIG. 21 is a plan view of an optical member according to an eleventh embodiment.

FIG. 22 is a side view of the optical member in a direction XXII in FIG. 21.

FIG. 23 is a side view of an optical member according to a twelfth embodiment, which corresponds to FIG. 22.

FIG. 24 is a side view of an optical member according to a thirteenth embodiment.

FIG. 25 is a rear view of the optical member in a direction XXV in FIG. 24.

### DETAILED DESCRIPTION

An optical member is used as a blind spot auxiliary device that projects an image of a blind spot area. The optical member has an entrance portion where an external light enters, an exit portion in which a prism portion and a flat surface are arranged alternately, and a smooth surface opposite to the exit portion and parallel to the flat surface. The optical member guides light incident on the entrance portion while totally reflecting light on the flat surface and the smooth surface, and emits light from the prism portion of the exit portion, thereby displaying an image of a blind spot area.

However, in the optical member, if the smooth surface undergoes shape changes such as warping or swelling over time, causing a decrease in flatness, it may become difficult to maintain the smooth surface and the flat surface parallel to each other. In that case, display distortion and parallax occur, causing degradation of the appearance of the display. Furthermore, since the optical member is a one-piece light guide made of the same material, or a light guide made of plural materials bonded together, it is difficult to correct only the change in shape of the smooth surface.

The present disclosure provides an optical member capable of keeping a smooth surface and a flat surface parallel to each other to restrict deterioration in the appearance of the display.

According to one aspect of the present disclosure, an optical member that internally reflects and guides an external light includes a light guide made of a light-transmitting material. The light guide includes an incident portion into which an external light enters, an exit portion including a surface onto which light entering from the incident portion first reaches, in which a protruding prism portion and a flat surface are alternately arranged, and a smooth surface opposite to the exit portion and parallel to the flat surface. The exit portion and the smooth surface are opposite to each other in an X direction, and the prism portion and the flat surface are alternately arranged in a Z direction. A direction perpendicular to the X direction and the Z direction is called as a Y direction. The light guide further has a reinforcing portion that protrudes or is recessed in the X direction from the flat surface or the smooth surface and extends in the Z direction.

Accordingly, the light guide has the reinforcing portion, which increases its rigidity, and suppresses deformation such as warping or swelling in the Z direction caused by changes over time in the smooth surface and the flat surface. Therefore, it is possible to suppress a decrease in flatness of the smooth surface and the flat surface, and to keep the smooth surface and the flat surface parallel to each other. Therefore, the optical member can restrict deterioration of the appearance of the display, such as display distortion and parallax.

In this disclosure, “parallel” refers to a substantially parallel state, and includes not only completely parallel, but also a nearly parallel state with slight differences due to manufacturing tolerances and the like.

According to another aspect of the present disclosure, an optical member that internally reflects and guides an external light includes a light guide made of a light-transmitting material. The light guide includes an incident portion into which an external light enters, an exit portion including a surface onto which light entering from the incident portion first reaches, in which a protruding prism portion and a flat surface are alternately arranged, and a smooth surface opposite to the exit portion and provided parallel to the flat surface. The exit portion and the smooth surface are opposite to each other in an X direction, and the prism portion and the flat surface are alternately arranged in a Z direction. A direction perpendicular to the X direction and the Z direction is called as a Y direction. The incident portion includes plural entrance prism portions arranged in the Z direction, each of which extending in the Y direction. The light guide further has a reinforcing portion that protrudes or is recessed in the X direction from the flat surface or the smooth surface and extends in the Z direction.

The optical member according to another aspect of the present disclosure also exhibits the same effects as the optical member according to one aspect of the present disclosure.

According to another aspect of the present disclosure, an optical member that internally reflects and guides an external light includes a light guide made of a light-transmitting material. The light guide includes an incident portion into which an external light enters, an exit portion including a surface onto which light entering from the incident portion first reaches, in which a protruding prism portion and a flat surface are alternately arranged, and a smooth surface opposite to the exit portion and provided parallel to the flat surface. The exit portion and the smooth surface are opposite to each other in an X direction, and the prism portion and the flat surface are alternately arranged in a Z direction. A direction perpendicular to the X direction and the Z direction is called as a Y direction. The light guide further has a reinforcing portion that protrudes or is recessed from the smooth surface in the X direction and extends in the Y direction. A refractive index of a medium outside the light guide is n1. A refractive index of the light guide is n2. A light guide angle ϕ is defined as an internal angle between the X direction and an incident direction of light incident from the incident portion to travel inside the light guide toward the flat surface and the smooth surface. The light guide angle is calculated by arcsin(n1/n2)=ϕ. The reinforcing portion is provided in a region opposite to the incident portion in the Z direction with respect to a line defined by an intersection between the smooth surface and a virtual plane inclined at the light guide angle with respect to the X direction to pass through a position of the prism portion located farthest from the incident portion in the Z direction and closest to the smooth surface.

Accordingly, the light guide has the reinforcing portion, which increases its rigidity, and restricts the smooth surface and the flat surface from changing in shape such as warping or swelling in the Y direction due to changes over time. Therefore, it is possible to suppress a decrease in flatness of the smooth surface and the flat surface, and to keep the smooth surface and the flat surface parallel to each other. Therefore, the optical member can restrict deterioration of the appearance of the display, such as display distortion and parallax. Furthermore, the reinforcing portion is provided in an area that does not contribute to guiding light. Since the light is not caught by the reinforcing portion, light scattering does not occur. Thus, a decrease in the brightness of the display can be restricted.

Hereinafter, embodiments of the present disclosure will be described with reference to the drawings. In the following embodiments, the same or equivalent parts are denoted by the same reference numerals as each other, and the explanations will be omitted.

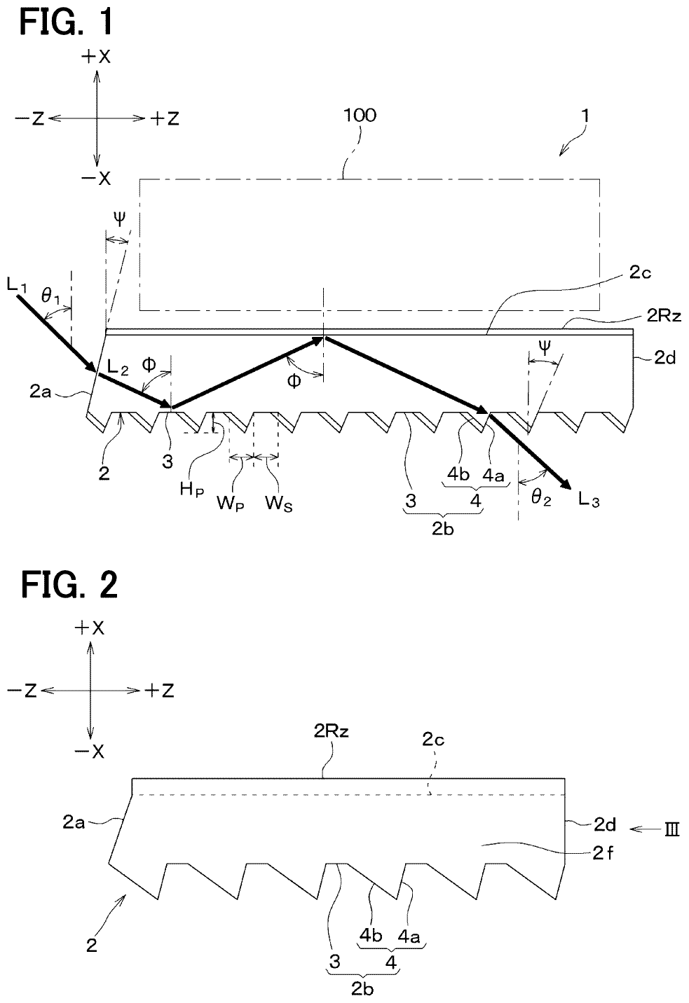

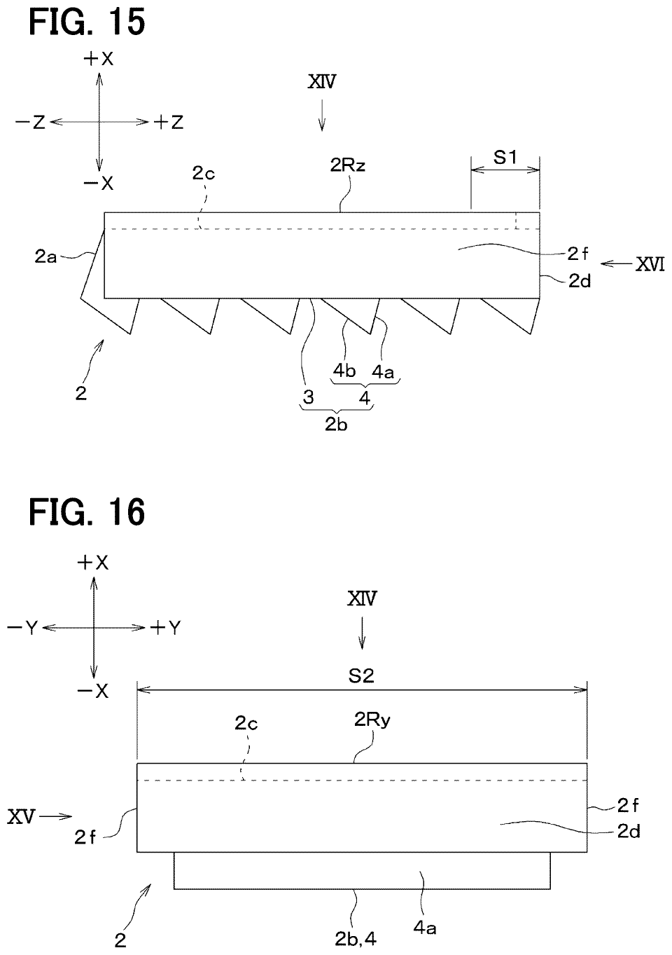

FIGS. 1 to 25 referred to in the description of each embodiment, the configuration of each part of the optical member 1 is simplified and depicted larger than the actual size for the purpose of explanation. FIGS. 2 to 25 show the configuration of each part of the optical member 1 more simply than in FIG. 1. Although FIG. 1 is a cross-sectional view of the optical member 1, hatching indicating the cross-section is omitted for ease of explanation.

### First Embodiment

An optical member 1 of the first embodiment will be described with reference to the drawings. As shown in FIG. 1, the optical member 1 of the first embodiment can be used as a blind spot auxiliary device that is attached to, for example, a light blocking body 100 or an obstacle that creates a blind spot by blocking a user's field of vision to allow the user to visually recognize the scene of the blind spot.

As shown in FIGS. 1 to 3, the optical member 1 according to the first embodiment includes a light guide 2 made of a light-transmitting material. The light guide 2 has an incident portion 2a, an exit portion 2b, a smooth surface 2c, a terminal surface 2d and a reinforcing portion 2Rz, and is capable of guiding an external light L1 by internally reflecting.

For ease of explanation, an external light incident on the incident portion 2a will be referred to as “external light L1”, a light incident from the incident portion 2a into the light guide 2 will be referred to as “incident light L2”, and a light emitted from the light guide 2 to the outside will be referred to as “emitted light L3”.

The incident portion 2a includes a surface through which an external light L1 enters the light guide 2. The exit portion 2b includes a surface on which the incident light L2 entering from the incident portion 2a first reaches, in which protruding prism portions 4 and flat surfaces 3 are arranged alternately. The smooth surface 2c is located opposite to the exit portion 2b, and is provided parallel to the flat surface 3. The reinforcing portion 2Rz will be described later.

For ease of explanation, a direction in which the flat surface 3 and the smooth surface 2c are opposite to each other will be referred to as “X direction” hereinafter. The X direction is perpendicular to the flat surface 3 and the smooth surface 2c. The X direction can also be said to be the thickness direction of the light guide 2. For convenience, a direction from the flat surface 3 toward the smooth surface 2c may be referred to as +X direction, and a direction from the smooth surface 2c toward the flat surface 3 may be referred to as −X direction. A direction in which the prism portions 4 and the flat surfaces 3 are arranged alternately is referred to as “Z direction.” The Z direction is perpendicular to the X direction. For convenience, a direction from the incident portion 2a toward the terminal surface 2d is referred to as +Z direction, in which the incident light L2 incident from the incident portion 2a is guided. A direction opposite to the +Z direction is referred to as −Z direction. Moreover, a direction perpendicular to the X direction and the Z direction is referred to as “Y direction.” Each of the prism portion 4 and the flat surface 3 extends in the Y direction.

As shown in FIG. 1, a portion of the incident light L2 entering the optical member 1 from the incident portion 2a is reflected by the flat surface 3 of the exit portion 2b, and the light reflected by the flat surface 3 is reflected by the smooth surface 2c and travels again toward the exit portion 2b. The optical member 1 guides the incident light L2 incident from the incident portion 2a inside the light guide 2, and emits the light to the outside from the prism portion 4 of the exit portion 2b. Thus, the optical member 1 allows a user adjacent to on the exit portion 2b to view the blind spot area created by the light blocking body 100 arranged adjacent to the smooth surface 2c. In addition, for example, in the case of in-vehicle use, the light blocking body 100 may be the A-pillar of a vehicle to create a blind spot area, but is not limited to this and can be modified as appropriate.

The light guide 2 is a substantially plate-like single member made of a light-transmitting material, for example, glass or resin material such as polyethylene terephthalate, polycarbonate, polyethylene, or acrylic. The light guide 2 is formed by, for example, resin injection molding. The light guide 2 is configured such that a portion of the incident light L2 is incident on the prism portion 4 of the exit portion 2b, and the remainder of the incident light L2 is reflected by the flat surface 3 toward the smooth surface 2c. The light guide 2 is designed so that the incident light L2 entering the light guide 2 from the incident portion 2a is totally reflected and guided by the smooth surface 2c and the flat surface 3. Specifically, assuming that the refractive index of medium (specifically, air) outside the light guide 2 is n1, and the refractive index of the constituent material of the light guide 2 is n2. An incident angle of the incident light L2 with respect to the smooth surface 2c and the flat surface 3, i.e., a light guide angle, is defined as ϕ, which satisfies the following Formula 1.

$$sin ϕ > n 1 / n 2 \qquad ( Formula 1 )$$

In more detail, the light guide angle ϕ is an internal angle between the X direction and an incident direction of the incident light L2 incident on the flat surface 3 and the smooth surface 2c to travel inside the light guide 2. As a result, the light guide 2 is able to repeatedly reflect a portion of the incident light L2 between the flat surface 3 and the smooth surface 2c, and emit the reflected light to the outside from the exit surface 4a of the prism portion 4, without having a half mirror or mirror made of a reflective material different from the light guide 2.

In the first embodiment, the incident portion 2a includes a surface that intersects with the exit portion 2b and the smooth surface 2c. The incident portion 2a is inclined toward the terminal surface 2d as extending from the exit portion 2b toward the smooth surface 2c. An internal angle between the incident portion 2a and the X direction is defined as an inclination angle ψ. The inclination angle ψ of the incident portion 2a is smaller than the light guide angle θ. An angle of the external light L1 with respect to the X direction is defined as θ1. The incident light L2 is refracted such that the light guide angle ϕ is larger than the angle θ1 of the external light L1, if the refraction condition satisfies ψ<π/2−ϕ, and guided to a wider range of the exit portion 2b. The angle 61 can also be said to be an angle of incidence of the external light L1 with respect to the light guide 2. The light guide 2 is configured to satisfy ϕ>ψ, due to ϕ>45.3, for example, ϕ is a total reflection angle, and since the refractive index of a typical light-transmitting resin material is 1.4 or more, in the formula of n2·sin ϕ>1.

The exit portion 2b is formed at a position adjacent to and intersecting with the incidence portion 2a. The exit portion 2b has prism portions 4, each of which is a protrusion having a triangular shape in the cross-section, and flat surfaces 3. The prism portions 4 and the flat surfaces 3 are arranged alternately from the incident portion 2a toward the terminal surface 2d.

The prism portion 4 protrudes from the flat surface 3 in the −X direction. The prism portions 4 have the same height Hp protruding in the −X direction and the same width Wp in the Z direction. In this disclosure, the term “same” refers to being substantially the same, and includes not only completely the same, but also being almost the same with slight differences due to manufacturing tolerances and the like. Each of the prism portions 4 has an exit surface 4a to emit a portion of the incident light L2 to the outside, and another surface 4b adjacent to the exit surface 4a. The exit surface 4a of the prism portion 4 is parallel to the incident portion (surface) 2a and has an inclination angle ψ with respect to the X direction. As a result, a part of the incident light L2 that reaches the exit surface 4a is emitted to the outside as the emitted light L3 at the same angle 62 as the external light L1. Therefore, when viewed from a user positioned adjacent to the exit portion 2b, continuity is ensured between the outside view not passing through the optical member 1 and the outside view of the blind spot area made visible by the optical member 1 (i.e., the display by the optical member 1). An interval between the prism portions 4 adjacent to each other in the Z direction is constant (i.e., the width Ws of the flat surface 3 in the Z direction).

The flat surfaces 3 are formed opposite the smooth surface 2c and parallel to the smooth surface 2c. In this disclosure, “parallel” refers to a substantially parallel state, and includes not only completely parallel, but also a nearly parallel state with slight differences due to manufacturing tolerances and the like. The flat surfaces 3 are arranged on the same plane. Since the incident light L2 from the incident portion 2a is incident at an angle equal to or larger than the critical angle, the flat surface 3 functions as reflecting surface to reflect the incident light L2 toward the smooth surface 2c by total reflection.

The terminal surface 2d connects the exit portion 2b and the smooth surface 2c. The inclination of the terminal surface 2d is arbitrary. The light guide 2 has side surfaces 2f located at both ends in the Y direction to connect the incident portion 2a, the exit portion 2b, the smooth surface 2c, and the terminal surface 2d. The side surfaces 2f do not contribute optically, and their shape, configuration, and the like are arbitrary. The basic configuration of the optical member 1 has been described above.

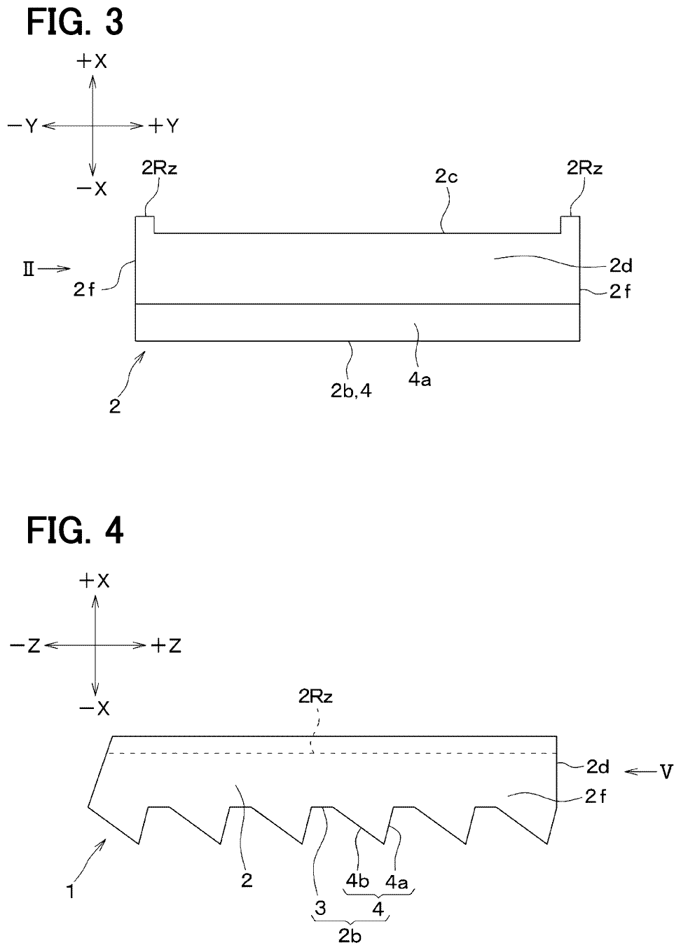

Next, the reinforcing portion 2Rz will be described with reference to FIGS. 2 and 3.

The light guide 2 may be unable to maintain the smooth surface 2c and the flat surface 3 parallel to each other if the smooth surface 2c undergoes a change in shape, such as warping or swelling, due to changes over time, resulting in a decrease in flatness. In that case, display distortion and parallax occur, causing degradation of the appearance of the display.

The optical member 1 has the reinforcing portion 2Rz on a part of the light guide 2 adjacent to the smooth surface 2c. In the first embodiment, the reinforcing portion 2Rz has a protrusion that protrudes from the smooth surface 2c in the +X direction and extends in the Z direction. Further, the reinforcing portion 2Rz is provided on both ends in the Y direction of the smooth surface 2c. The reinforcing portion 2Rz has, for example, a quadrangular shape in a cross-section (the XY plane) perpendicular to the Z direction.

In the first embodiment, the reinforcing portion 2Rz is made of the same light-transmitting material as that of the light guide 2. The reinforcing portion 2Rz can be formed integrally and continuously with the light guide 2 by, for example, resin injection molding. However, without being limited thereto, the reinforcing portion 2Rz may be formed of a material other than the light-transmitting material constituting the light guide 2 and joined to the light guide 2.

The reinforcing portion 2Rz of the first embodiment functions like a beam for the light guide 2, and can increase the rigidity of the light guide 2. The reinforcing portion 2Rz suppresses deformations of the smooth surface 2c and the flat surface 3 in the X direction, such as warping or swelling, caused by changes over time in the Z direction. Therefore, the decrease in flatness of the smooth surface 2c and the flat surface 3 is suppressed, and the smooth surface 2c and the flat surface 3 can be kept parallel to each other. Therefore, the optical member 1 can restrict deterioration of the appearance of the display, such as display distortion and parallax.

The second to eighth embodiments are different from the first embodiment in the configuration of the reinforcing portion 2Rz, but are otherwise similar to the first embodiment, so only the parts that differ from the first embodiment will be described.

### Second Embodiment

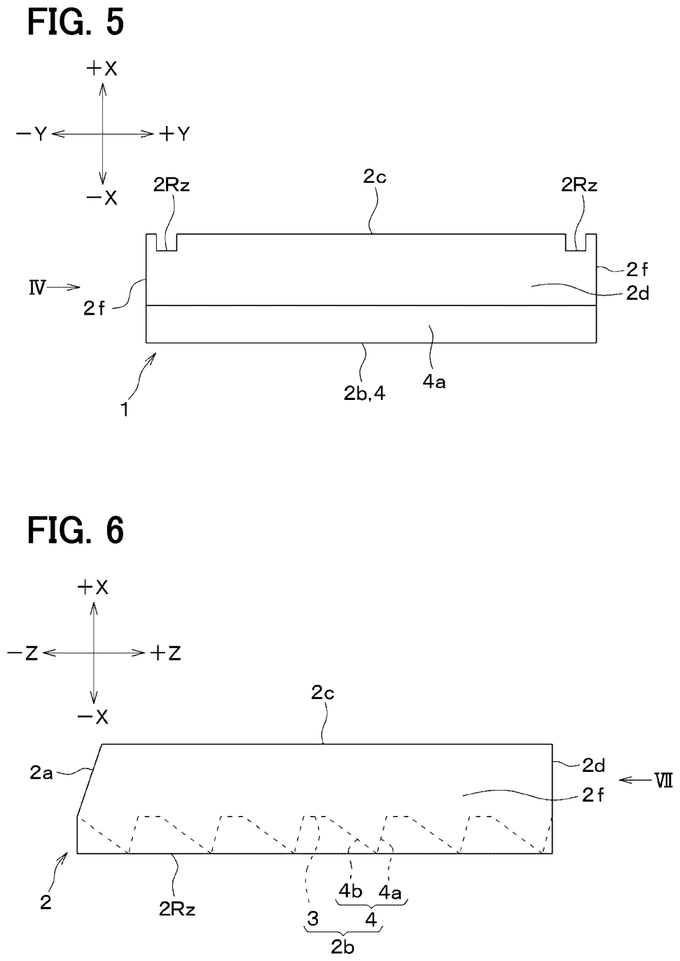

A second embodiment will be described. As shown in FIGS. 4 and 5, the reinforcing portion 2Rz of the optical member 1 of the second embodiment has a groove shape recessed in the −X direction from the smooth surface 2c and extending in the Z direction, that is, a concave shape. The reinforcing portion 2Rz is located inward of the side surfaces 2f of the light guide 2 in the Y direction. The reinforcing portion 2Rz is formed integrally with the light guide 2 by, for example, resin injection molding. That is, the reinforcing portion 2Rz is made of the same light-transmitting material as the light guide 2.

The reinforcing portion 2Rz of the second embodiment increases the rigidity of the light guide 2 through its concave shape, thereby restricting the smooth surface 2c and the flat surface 3 from undergoing shape changes in the X direction such as warping or swelling due to changes over time in the Z direction. Therefore, the decrease in flatness of the smooth surface 2c and the flat surface 3 is suppressed, and the smooth surface 2c and the flat surface 3 are kept parallel to each other. Therefore, the optical member 1 can restrict deterioration of the appearance of the display.

### Third Embodiment

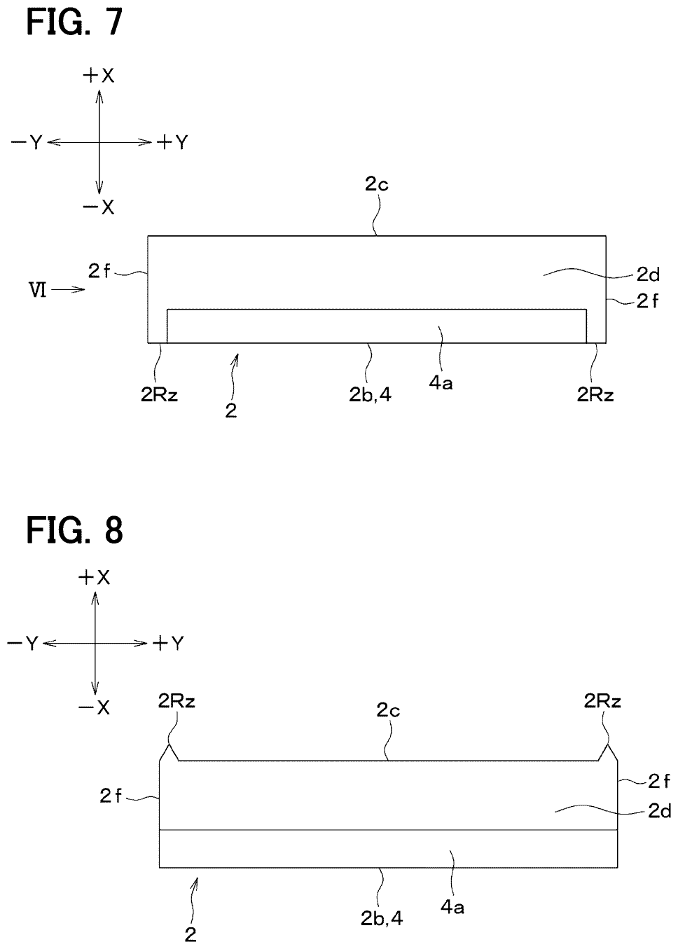

As shown in FIGS. 6 and 7, the optical member 1 of the third embodiment has a reinforcing portion 2Rz on the exit portion 2b of the light guide 2. The reinforcing portion 2Rz of the third embodiment protrudes from the flat surface 3 of the exit portion 2b in the −X direction and extends in the Z direction. Further, the reinforcing portion 2Rz is located outward of the prism portion 4 of the exit portion 2b in the Y direction, and is connected to the prism portion 4. The reinforcing portion 2Rz is formed integrally with the light guide 2 by, for example, resin injection molding. That is, the reinforcing portion 2Rz is made of the same light-transmitting material as the light guide 2.

The reinforcing portion 2Rz of the third embodiment functions like a beam for the light guide 2, and can increase the rigidity of the light guide 2. The reinforcing portion 2Rz suppresses deformations of the smooth surface 2c and the flat surface 3 in the X direction, such as warping or swelling, caused by changes over time in the Z direction. Therefore, the decrease in flatness of the smooth surface 2c and the flat surface 3 is suppressed, and the smooth surface 2c and the flat surface 3 can be kept parallel to each other. Therefore, the optical member 1 can restrict deterioration of the appearance of the display, such as display distortion and parallax.

### Fourth Embodiment

A fourth embodiment is a modification of the first embodiment. As shown in FIG. 8, the optical member 1 of the fourth embodiment has a reinforcing portion 2Rz that protrudes from the smooth surface 2c in the +X direction and extends in the Z direction. The reinforcing portion 2Rz has a triangular shape in the cross-section (the XY plane) perpendicular to the Z direction. The reinforcing portion 2Rz of the fourth embodiment also provides the same effects as those of the first embodiment.

### Fifth Embodiment

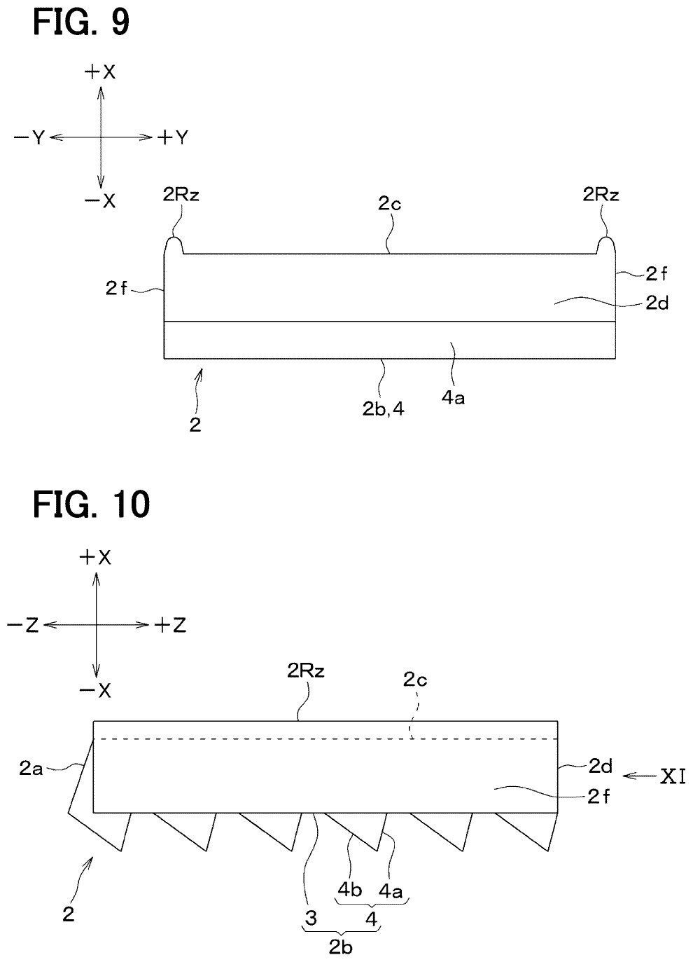

The fifth embodiment is a modification of the first embodiment. As shown in FIG. 9, the optical member 1 of the fifth embodiment has a reinforcing portion 2Rz that protrudes from the smooth surface 2c in the +X direction and extends in the Z direction. The surface of the reinforcing portion 2Rz facing in the +X direction has a curved shape that is convex in the +X direction in the cross-section (the XY plane) perpendicular to the Z direction. The reinforcing portion 2Rz of the fifth embodiment provides the same effects as those of the first embodiment.

### Sixth Embodiment

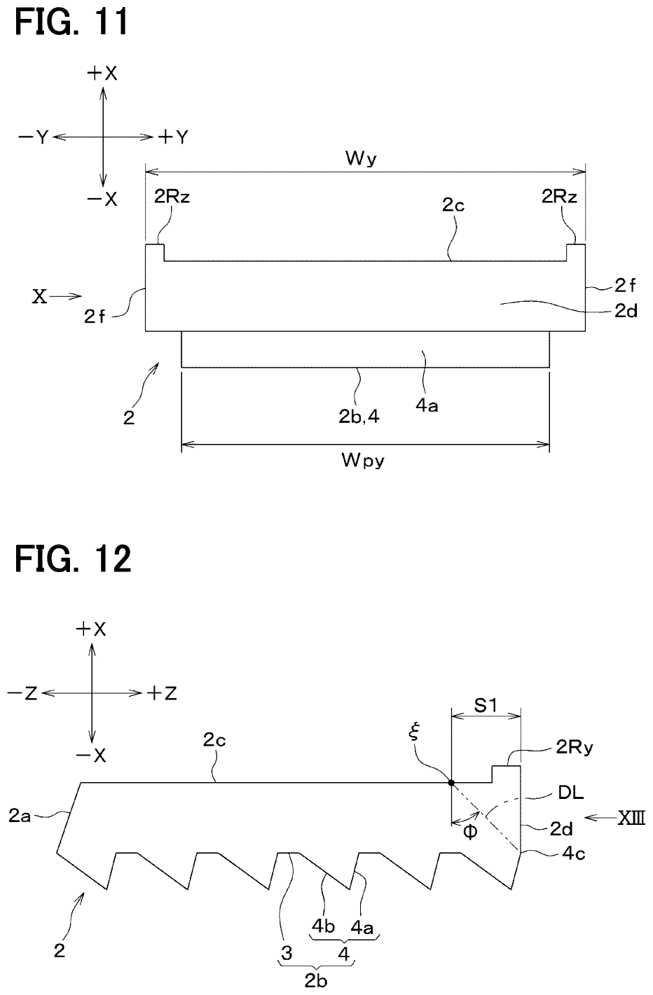

A sixth embodiment will be described. As shown in FIGS. 10 and 11, the optical member 1 of the sixth embodiment has a reinforcing portion 2Rz that protrudes from the smooth surface 2c in the +X direction and extends in the Z direction. In the sixth embodiment, the width Wy of the light guide 2 in the Y direction is larger than the width Wpy of the prism portion 4 of the exit portion 2b in the Y direction. The reinforcing portion 2Rz in the sixth embodiment is provided on the smooth surface 2c of the light guide 2 at a position further outward of the prism portion 4 of the exit portion 2b in the Y direction.

If the reinforcing portion 2Rz is positioned opposite the prism portion 4 in the X direction, light will be caught by the reinforcing portion 2Rz when the incident light L2 is reflected by the flat surface 3 and the smooth surface 2c and guided in the Z direction. In this case, since light scattering is generated, the brightness of the display is reduced.

In contrast, in the sixth embodiment, the reinforcing portion 2Rz is provided outward of the prism portion 4 in the Y direction. As a result, when the incident light L2 is reflected by the flat surface 3 and the smooth surface 2c and guided in the Z direction, the light does not get caught on the reinforcing portion 2Rz and no light scattering occurs, thereby restricting a decrease in the brightness of the display.

### Seventh Embodiment

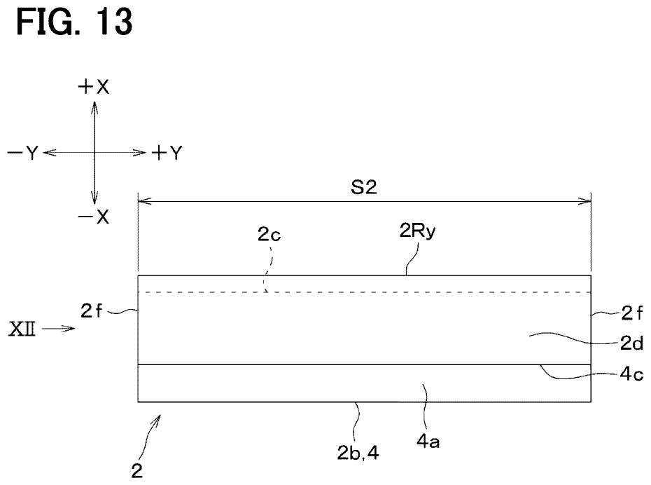

A seventh embodiment will be described. As shown in FIGS. 12 and 13, in the seventh embodiment, the reinforcing portion 2Ry is provided on the smooth surface 2c of the light guide 2 at a position adjacent to the terminal surface 2d. The reinforcing portion 2Ry protrudes from the smooth surface 2c in the +X direction and extends in the Y direction. In the following description, the reinforcing portion 2Rz extending in the Z direction in the first to sixth embodiments may be referred to as “first reinforcing portion 2Rz,” and the reinforcing portion 2Ry extending in the Y direction in the seventh embodiment may be referred to as “second reinforcing portion 2Ry.”

FIGS. 12 and 13 illustrate the area where the second reinforcing portion 2Ry can be provided, as indicated by arrows S1 and S2. This area is defined as follows.

First, a double chain line DL in FIG. 12 indicates a virtual plane that passes through the position 4c of the prism portion 4 farthest from the incident portion 2a in the Z direction and closest to the smooth surface 2c, and is inclined at a light guide angle ϕ with respect to the X direction. The light guide angle ϕ is calculated by the following Formula 2, in which n1 is the refractive index of medium (specifically, air) outside the light guide 2, and n2 is the refractive index of the light guide 2.

$$arc sin ( n 1 / n 2 = ϕ ) \qquad ( Formula 2 )$$

Next, ξ in FIG. 12 indicates an intersection line where the imaginary plane indicated by the double chain line DL intersects with the smooth surface 2c. The area in the +Z direction from the line (that is, the area between the terminal surface 2d and the line ξ) is defined by the arrow S1, S2. This area of the smooth surface 2c does not contribute to guiding light. The second reinforcing portion 2Ry is provided in this area.

The second reinforcing portion 2Ry provided in the optical member 1 of the seventh embodiment extends in the Y direction, thereby making it possible to suppress shape changes such as warping or swelling in the X direction, on the smooth surface 2c and the flat surface 3 due to changes over time, in the Y direction. Therefore, the decrease in flatness of the smooth surface 2c and the flat surface 3 is suppressed, and the smooth surface 2c and the flat surface 3 can be kept parallel to each other.

Furthermore, the second reinforcing portion 2Ry included in the optical member 1 of the seventh embodiment is provided in the area defined by the arrow S1, S2. This area does not contribute to guiding light. Therefore, the light is not caught by the second reinforcing portion 2Ry and light scattering does not occur, so that a decrease in the brightness of the display can be restricted.

### Eighth Embodiment

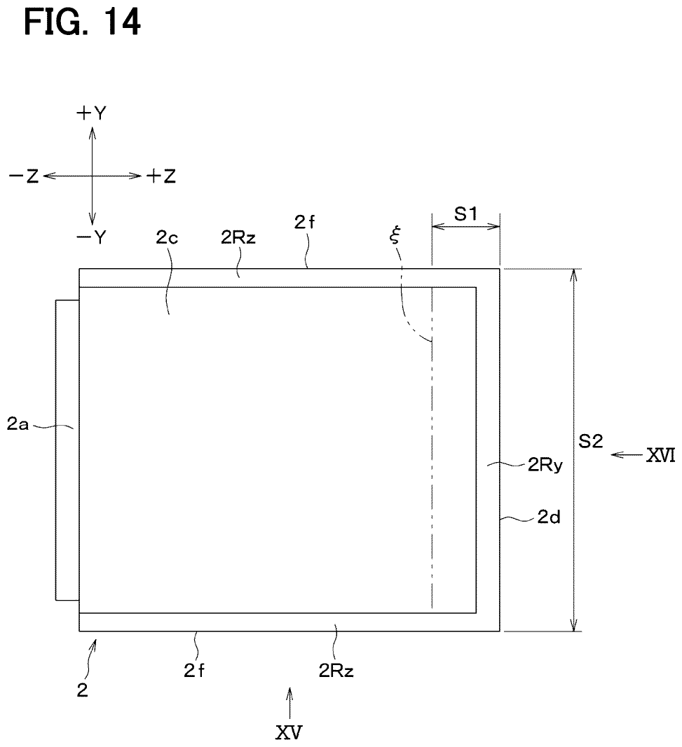

As shown in FIGS. 14 to 16, the optical member 1 of the eighth embodiment has the first reinforcing portion 2Rz of the sixth embodiment and the second reinforcing portion 2Ry of the seventh embodiment. The both ends of the second reinforcing portion 2Ry in the Y direction are formed continuously with the end of the first reinforcing portion 2Rz adjacent to the terminal surface 2d.

In the optical member 1 of the eighth embodiment, the first reinforcing portion 2Rz and the second reinforcing portion 2Ry can suppress shape changes in the smooth surface 2c and the flat surface 3, such as warping and swelling in the X direction, respectively, in the Z direction and the Y direction.

Furthermore, in the eighth embodiment, the first reinforcing portion 2Rz is provided outward of the prism portion 4 in the Y direction, and the second reinforcing portion 2Ry is provided in the area defined by the arrow S1, S2. As a result, light is not caught by the first reinforcing portion 2Rz and the second reinforcing portion 2Ry, and light scattering does not occur, so that a decrease in the brightness of the display can be restricted.

The ninth and tenth embodiments are different from the first embodiment etc. in that a light absorbing portion is provided, but other aspects are similar to the first embodiment etc., so only the parts that differ from the first embodiment etc. will be described.

### Ninth Embodiment

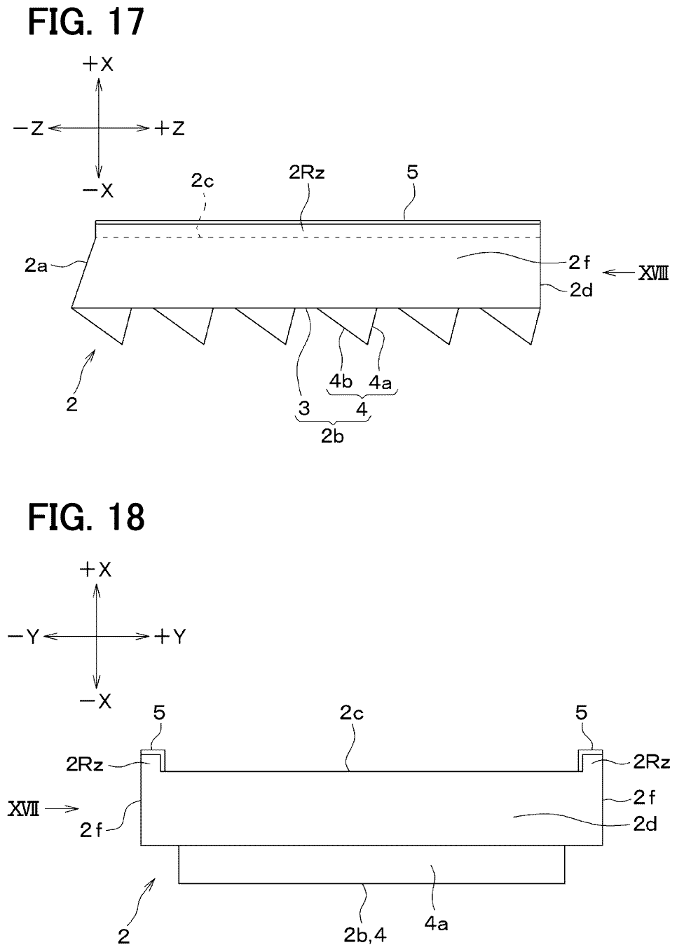

As shown in FIGS. 17 and 18, the reinforcing portion 2Rz of the optical member 1 of the ninth embodiment is the same as that described in the sixth embodiment. Furthermore, the optical member 1 of the ninth embodiment includes a light absorbing portion 5 that covers the reinforcing portion 2Rz. The light absorbing portion 5 is formed of, for example, a black sheet or black paint that absorbs light. The light absorbing portion 5 is provided at least at the corner of the reinforcing portion 2Rz. Specifically, the light absorbing portion 5 is provided on a surface of the reinforcing portion 2Rz facing in the +X direction and a surface of the reinforcing portion 2Rz facing inward in the Y direction. When a holder (not shown) is provided on the side surface 2f of the light guide 2 facing outward in the Y direction, the light absorbing portion 5 may not be necessary.

However, if the light absorbing portion 5 is not provided at the corner of the reinforcing portion 2Rz, when the incident light L2 is reflected by the flat surface 3 and the smooth surface 2c and guided in the Z direction, there is a concern that the light will reach the corner of the reinforcing portion 2Rz, causing light scattering and deteriorating the appearance of the display.

In contrast, the optical member 1 of the ninth embodiment includes the light absorbing portion 5 covering at least the corner of the reinforcing portions 2Rz. Thus, the light that reaches the corner of the reinforcing portions 2Rz is absorbed by the light absorbing portion 5. Therefore, the optical member 1 can restrict light scattering that occurs when light reaches the corner of the reinforcing portion 2Rz, and can restrict deterioration in the appearance of the display.

### Tenth Embodiment

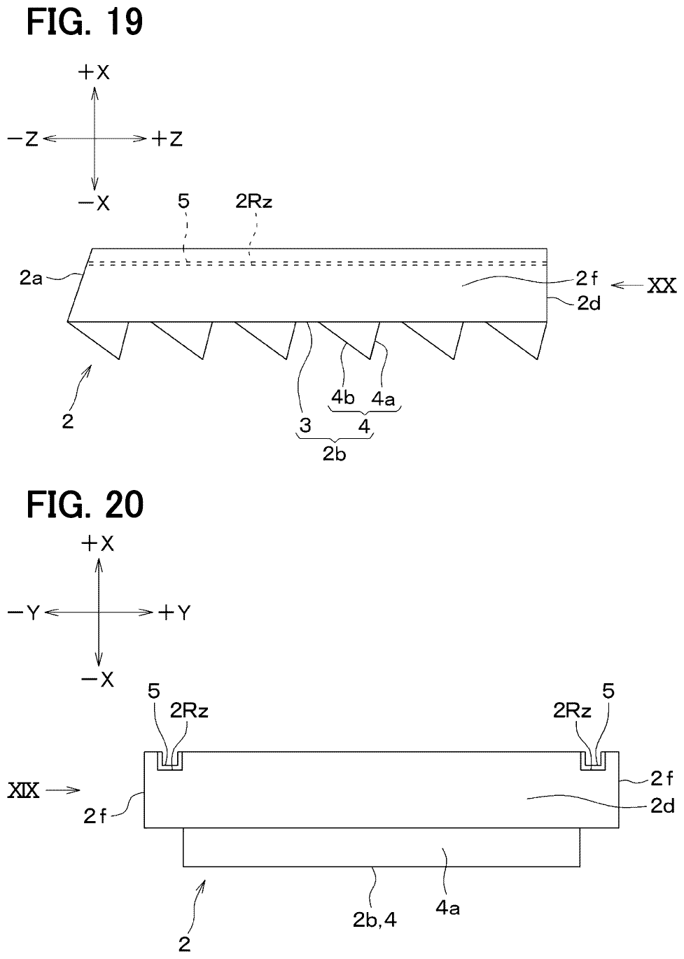

As shown in FIGS. 19 and 20, the reinforcing portion 2Rz of the optical member 1 of the tenth embodiment has a groove shape recessed in the −X direction from the smooth surface 2c and extending in the Z direction, that is, a concave shape. The reinforcing portion 2Rz is provided on the smooth surface 2c at a position further outward of the prism portion 4 of the exit portion 2b in the Y direction. The optical member 1 of the tenth embodiment includes the light absorbing portion 5 that cover the corner of the reinforcing portions 2Rz. The light absorbing portion 5 is provided so as to cover the inner surface of the reinforcing portion 2Rz including the corner.

The optical member 1 of the tenth embodiment is provided with the light absorbing portion 5 that covers the inner surface, including the corner, of the reinforcing portion 2Rz, thereby restricting light scattering that occurs when light reaches the reinforcing portion 2Rz and restricting deterioration of the appearance of the display.

In the eleventh and twelfth embodiments, in comparison with the first embodiment etc., the incident portion 2a includes plural entrance prism portions 6, but the rest is similar to the first embodiment etc., so only the parts that differ from the first embodiment etc. will be described.

### Eleventh Embodiment

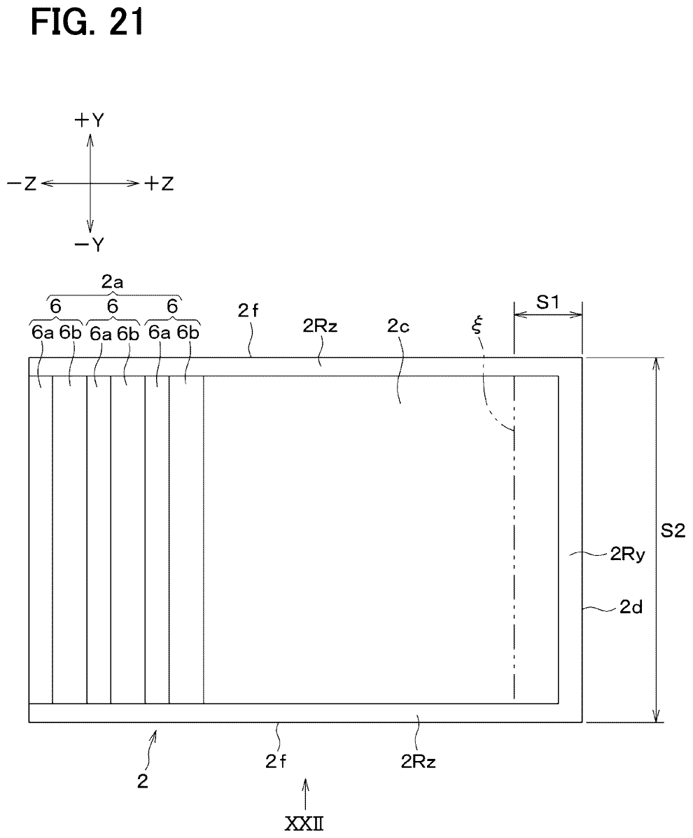

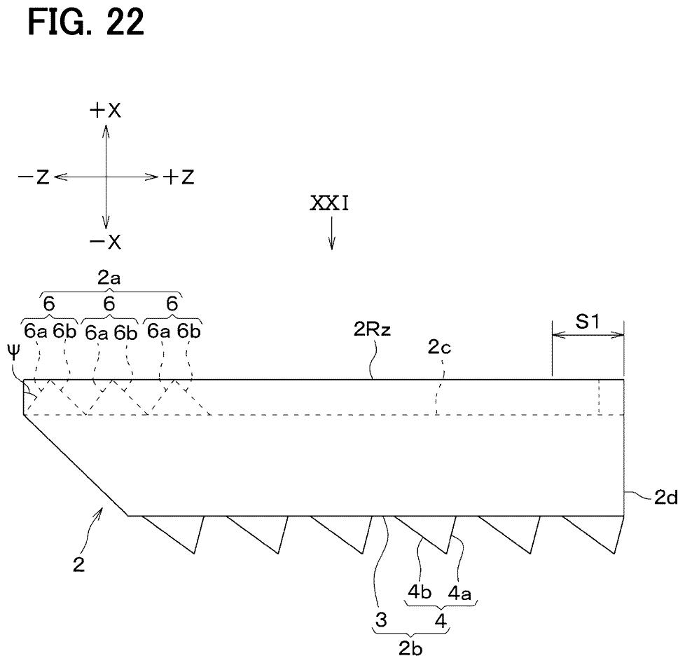

As shown in FIGS. 21 and 22, an incident portion 2a of an optical member 1 according to the eleventh embodiment is composed of plural entrance prism portions 6. The entrance prism portion 6 protrudes from the smooth surface 2c in the +X direction. The entrance prism portions 6 are arranged in the Z direction, each of which extending in the Y direction. A joint between the entrance prism portions 6 (i.e., the valley between the entrance prism portions 6) is provided on the same plane as the smooth surface 2c. In the following description, of the entrance prism portions 6, a surface facing opposite to the terminal surface 2d is referred to as “prism incident surface 6a”, and a surface facing toward the terminal surface 2d is referred to as “prism other surface 6b”. The inclination angle ψ of the prism incident surface 6a is the same as the inclination angle LP of the incident portion 2a described in the first embodiment.

The optical member 1 of the eleventh embodiment is configured such that a portion of the incident light L2 entering the light guide 2 from the prism incident surface 6a is reflected by the flat surface 3 of the exit portion 2b, and the light reflected by the flat surface 3 is reflected by the smooth surface 2c and returns toward the exit portion 2b. The optical member 1 guides the incident light L2 incident from the prism incident surface 6a inside the light guide 2, and emits the light to the outside from the prism portion 4 of the exit portion 2b. Thus, the optical member 1 allows a user around the exit portion 2b to view the blind spot area due to the light blocking body 100 located adjacent to the smooth surface 2c.

The optical member 1 of the eleventh embodiment has a first reinforcing portion 2Rz and a second reinforcing portion 2Ry. The first reinforcing portion 2Rz is provided outward of the entrance prism portion 6 in the Y direction. The both ends of the second reinforcing portion 2Ry in the Y direction are formed continuously with the end of the first reinforcing portion 2Rz adjacent to the terminal surface 2d. Moreover, the first reinforcing portion 2Rz is provided outward of the prism portion 4 of the exit portion 2b in the Y direction.

In the optical member 1 of the eleventh embodiment, the first reinforcing portion 2Rz and the second reinforcing portion 2Ry can suppress shape changes such as warping or swelling in the X direction, on the smooth surface 2c and the flat surface 3 in the Z direction and the Y direction respectively.

Furthermore, in the eleventh embodiment, the first reinforcing portion 2Rz is provided further outward of the entrance prism portions 6 in the Y direction, and is provided further outward of the prism portions 4 of the exit portion 2b in the Y direction. The second reinforcing portion 2Ry is provided in the region defined by the arrow S1, S2. As a result, the light guided through the light guide 2 is not caught by the first reinforcing portion 2Rz and the second reinforcing portion 2Ry, and no light scattering occurs, so that a decrease in the brightness of the display can be restricted.

### Twelfth Embodiment

The twelfth embodiment is different from the eleventh embodiment in that the height of the first reinforcing portion 2Rz and the second reinforcing portion 2Ry in the X direction is changed, but otherwise is similar to the eleventh embodiment, so only the parts that differ from the eleventh embodiment will be described.

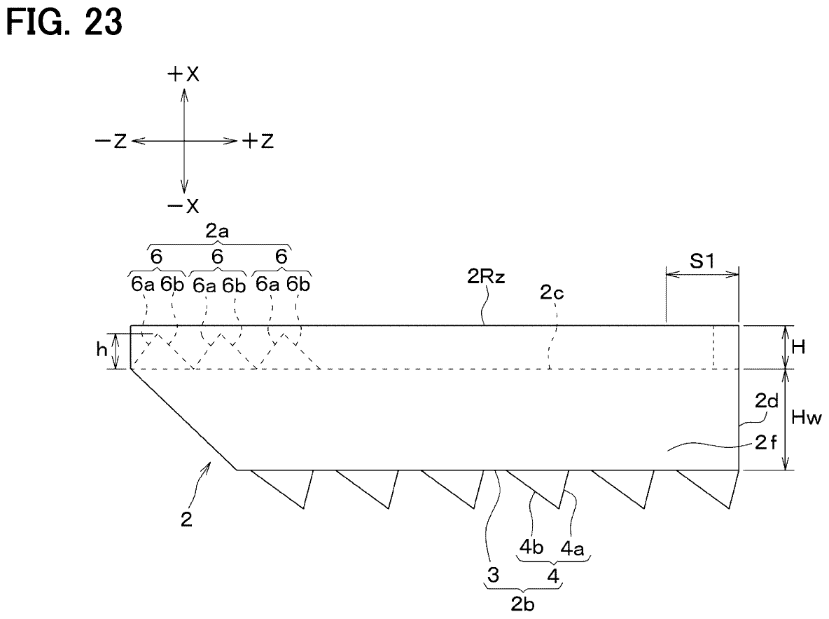

As shown in FIG. 23, in the eleventh embodiment, the height of the first reinforcing portion 2Rz and the second reinforcing portion 2Ry in the X direction is defined as H. The distance between the flat portion and the smooth surface 2c is defined as Hw, and the height of the entrance prism portion 6 in the X direction is defined as h. At this time, the relationship expressed by the following Formula 3 and Formula 4 is satisfied.

$$H \leq 3 Hw \qquad ( Formula 3 )$$

$$H > h \qquad ( Formula 4 )$$

According to Formula 3, the height H of the first reinforcing portion 2Rz and the second reinforcing portion 2Ry in the X direction is set to be three times or less the distance Hw between the flat portion and the smooth surface 2c. This makes it possible to restrict air bubbles from being mixed into the first reinforcing portion 2Rz and the second reinforcing portion 2Ry when the light guide 2 is formed by resin injection molding, and further makes it possible to restrict poor release of the first reinforcing portion 2Rz and the second reinforcing portion 2Ry from the injection molding die.

In addition, when the light guide 2 is stored in a holder (not shown), Formula 4 makes it possible to restrict the apex of the entrance prism portion 6 from interfering with the inner surface of the holder, thereby restricting the entrance prism portion 6 from being scratched. Although this is not intended to limit the present disclosure, it is preferable to set, for example, Hw=10 (mm), h=1 (mm), and H=0.1+h (mm).

### Thirteenth Embodiment

The thirteenth embodiment is different from the sixth embodiment in that the number of reinforcing portions 2Rz is changed, but the rest is similar to the sixth embodiment, so only the parts that are different from the sixth embodiment will be described.

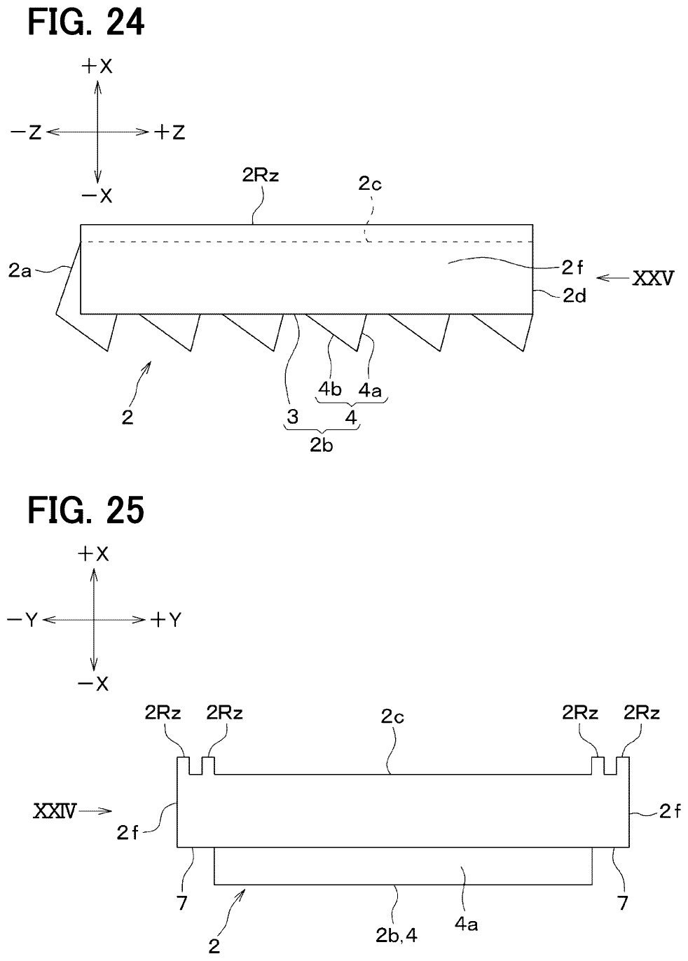

As shown in FIGS. 24 and 25, the optical member 1 of the thirteenth embodiment has plural reinforcing portions 2Rz protruding from the smooth surface 2c in the +X direction and extending in the Z direction. Specifically, as shown in FIG. 25, two reinforcing portions 2Rz are provided at one end of the smooth surface 2c in the Y direction, and two reinforcing portions 2Rz are provided at the other end of the smooth surface 2c in the Y direction. Each of the reinforcing portions 2Rz is provided on the smooth surface 2c at a position outward of the prism portion 4 of the exit portion 2b in the Y direction.

In the thirteenth embodiment, the width of the light guide 2 in the Y direction is larger than the width of the prism portion 4 of the exit portion 2b in the Y direction. Therefore, a step surface 7 is provided outward of the prism portion 4 of the exit portion 2b in the Y direction. Each of the reinforcing portions 2Rz is provided on the smooth surface 2c of the light guide 2 at a position opposite to the step surface 7 in the X direction.

In case where the light guide 2 is formed by resin injection molding, if the volume of the reinforcing portion 2Rz is increased, there is a concern that a molding defect called a sink mark will occur on the step surface 7.

In contrast, in the thirteenth embodiment, the reinforcing portions 2Rz are provided at one side in the Y direction, and the other side in the Y direction. This can reduce molding defects of the step surface 7 when the light guide 2 is formed by resin injection molding.

### Other Embodiment

(1) In each of the embodiments, the reinforcing portion 2Rz, 2Ry is made of the same light-transmitting material as the light guide 2. However, the reinforcing portion 2Rz, 2Ry is not limited to this. For example, the reinforcing portion 2Rz, 2Ry may be formed of a material different from the light-transmitting material of the light guide 2 and joined to the light guide 2. In this case, the reinforcing portion 2Rz, 2Ry may be made of a metal such as aluminum, a resin such as polypropylene, or rubber. The rubber is preferably a hard rubber. This makes it possible to fit the reinforcing portion 2Rz, 2Ry to the light guide 2 and take measures to restrict a decrease in the flatness of the smooth surface 2c and the flat surface 3, thereby making it possible to keep the smooth surface 2c and the flat surface 3 parallel to each other. Therefore, the optical member 1 can restrict deterioration of the appearance of the display, such as display distortion and parallax.

(2) In the first, fourth, and fifth embodiments, the cross-sectional shape of the reinforcing portion 2Rz is exemplified as a rectangular shape, a triangular shape, and a curved shape, but not limited to these, and any shape can be adopted for the reinforcing portion 2Rz, 2Ry.

(3) In the seventh and eighth embodiments, the second reinforcing portion 2Ry has a convex shape that protrudes from the smooth surface 2c in the +X direction. However, the second reinforcing portion 2Ry is not limited to this, and may have a concave shape that is recessed from the smooth surface 2c in the −X direction.

(4) In the thirteenth embodiment, the first reinforcing portions 2Rz are configured on one side in the Y direction, and on the other side in the Y direction. Further, not limited to this, for example, the second reinforcing portion 2Ry may be one of plural second reinforcing portions 2Ry.

The present disclosure is not limited to the embodiments described above, and can be modified as appropriate within the scope described in the claims. The above-described embodiments and a part thereof are not irrelevant to each other, and can be appropriately combined with each other unless the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Further, in each of the above-mentioned embodiments, when referring to the shape, positional relationship, and the like of a component and the like, the component is not limited to the shape, positional relationship, and the like, except for the case where the component is specifically specified, the case where the component is fundamentally limited to a specific shape, positional relationship, and the like.

What is claimed is:

1. An optical member configured to internally reflect and guide an external light, the optical member comprising:
a light guide made of a light-transmitting material, the light guide having
an incident portion into which the external light is incident,
an exit portion including a surface onto which light incident from the incident portion first reaches, in which a protruding prism portion and a flat surface are alternately arranged, and
a smooth surface opposite to the exit portion as parallel to the flat surface, wherein
the exit portion and the smooth surface are opposite to each other in an X direction,
the prism portion and the flat surface are alternately arranged in a Z direction,
a direction perpendicular to the X direction and the Z direction is referred to as a Y direction, and
the light guide further has a reinforcing portion that protrudes or is recessed in the X direction from the flat surface or the smooth surface and extends in the Z direction.

2. An optical member configured to internally reflect and guide an external light, the optical member comprising:
a light guide made of a light-transmitting material, the light guide having
an incident portion into which the external light is incident,
an exit portion including a surface onto which light incident from the incident portion first reaches, in which a protruding prism portion and a flat surface are alternately arranged, and
a smooth surface opposite to the exit portion as parallel to the flat surface, wherein
the exit portion and the smooth surface are opposite to each other in an X direction,
the prism portion and the flat surface are alternately arranged in a Z direction,
a direction perpendicular to the X direction and the Z direction is referred to as a Y direction,
the incident portion includes a plurality of entrance prism portions arranged in the Z direction, each of which extending in the Y direction, and
the light guide further has a reinforcing portion that protrudes or is recessed in the X direction from the flat surface or the smooth surface and extends in the Z direction.

3. The optical member according to claim 2, wherein
the reinforcing portion protrudes from the smooth surface in the X direction,
a height of the reinforcing portion in the X direction is defined as H,
a distance between an apex of the entrance prism portion and the smooth surface in the X direction is defined as h, and
a relationship of H>h is satisfied.

4. The optical member according to claim 1, wherein the reinforcing portion is located at a position on the light guide further outward of the prism portion in the Y direction.

5. The optical member according to claim 1, wherein
the reinforcing portion is referred to as a first reinforcing portion,
the light guide further has a second reinforcing portion that protrudes or is recessed from the smooth surface in the X direction and extends in the Y direction,
a refractive index of a medium outside the light guide is n1,
a refractive index of the light guide is n2,
a light guide angle ϕ is defined as an internal angle between the X direction and an incident direction of light incident from the incident portion to travel inside the light guide on the flat surface and the smooth surface,
the light guide angle is calculated by arcsin(n1/n2)=ϕ, and
the second reinforcing portion is provided in a region opposite to the incident portion in the Z direction with respect to a line defined by an intersection between the smooth surface and a virtual plane inclined at the light guide angle with respect to the X direction to pass through a position of the prism portion located farthest from the incident portion in the Z direction and closest to the smooth surface.

6. The optical member according to claim 1, wherein
the reinforcing portion protrudes from the smooth surface in the X direction,
a height of the reinforcing portion in the X direction is defined as H,
a distance between the flat surface and the smooth surface is defined as Hw, and
a relationship of H≤3×Hw is satisfied.

7. The optical member according to claim 1, further comprising a light absorbing portion covering a corner of the reinforcing portion.

8. The optical member according to claim 1, wherein the reinforcing portion is made of a same material as that of the light guide and is formed continuous with the light guide.

9. The optical member according to claim 1, wherein
the reinforcing portion protrudes in the X direction from the flat surface or the smooth surface, and
the reinforcing portion is made of a material different from the light-transmitting material of the light guide and is joined to the light guide.

10. The optical member according to claim 1, wherein the reinforcing portion is one of a plurality of reinforcing portions provided on one side in the Y direction and a plurality of reinforcing portions provided on the other side in the Y direction.

11. An optical member configured to internally reflect and guide an external light, the optical member comprising:
a light guide made of a light-transmitting material, the light guide having
an incident portion into which the external light is incident,
an exit portion including a surface onto which light incident from the incident portion first reaches, in which a protruding prism portion and a flat surface are alternately arranged, and
a smooth surface opposite to the exit portion as parallel to the flat surface, wherein
the exit portion and the smooth surface are opposite to each other in an X direction,
the prism portion and the flat surface are alternately arranged in a Z direction,
a direction perpendicular to the X direction and the Z direction is referred to as a Y direction,
the light guide further has a reinforcing portion that protrudes or is recessed from the smooth surface in the X direction and extends in the Y direction,
a refractive index of a medium outside the light guide is n1,
a refractive index of the light guide is n2,
a light guide angle ϕ is defined as an internal angle between the X direction and an incident direction of light incident from the incident portion to travel inside the light guide on the flat surface and the smooth surface,
the light guide angle is calculated by arcsin(n1/n2)=ϕ, and
the reinforcing portion is provided in a region opposite to the incident portion in the Z direction with respect to a line defined by an intersection between the smooth surface and a virtual plane inclined at the light guide angle with respect to the X direction to pass through a position of the prism portion located farthest from the incident portion in the Z direction and closest to the smooth surface.

12. The optical member according to claim 11, wherein the incident portion includes a plurality of entrance prism portions arranged in the Z direction, each of which extending in the Y direction.
